(19) United States
(12) Patent Application Publication
(10) Pub. No.: US 2018/0163915 A1
(43) Pub. Date: Jun. 14, 2018

(54) NOVELTY HELMET ASSEMBLIES AND METHODS OF USING THE SAME

(71) Applicant: Kristine Marie Halper, (US)

(72) Inventors: Kristine Marie Halper, Mokena, IL (US); David Adam Carta, Elmhurst, IL (US)

(21) Appl. No.: 15/374,716

(22) Filed: Dec. 9, 2016

(51) Int. Cl. F16M 11/04; F16M 11/22; A47F 5/04; A47F 7/06

(52) U.S. Cl. CPC F16M 11/041; A47F 7/06; A47F 5/04; F16M 11/22

(57) ABSTRACT

An assembly includes a helmet and a stand. The helmet includes a first half having a first pair of plates and a second half having a second pair of plates. Each of the first pair of plates and each of the second pair of plates forms a respective notch. Responsive to the first half of the helmet being directly attached to the second half of the helmet, the first pair of plates aligns with the second pair of plates thereby forming a pair of brackets. Each of the brackets has a bracket opening. The stand includes a body and a coupling mechanism. The coupling mechanism includes a first deflectable arm having a first locking tab and an opposing second deflectable arm having a second locking tab. The first locking tab and second locking tab directly engage the bracket openings such that the helmet is rigidly coupled to the stand.

### TECHNICAL FIELD

The present disclosure relates generally to a novelty helmet assembly and, more particularly, to a novelty helmet assembly that rigidly couples a novelty helmet with a stand that is capable of being mounted on a surface.

### BACKGROUND

Many student athletes and sports fans desire ways of expressing their admiration for their team(s). One way of such expression is a bumper sticker with their team's logo. However, such stickers are only two dimensional and not as exciting as a three dimensional novelty item. However, mounting such three dimensional novelty item in, for example, a moving automobile presents challenges. Further, some such novelty items are smaller versions of equipment (e.g., helmets) used by players. Mass producing such miniature equipment such that the novelty item can be properly mounted within the automobile further complicates the production process. The present disclosure is directed to solving these and other problems.

### SUMMARY

According to some implementations of the present disclosure, a novelty helmet assembly includes a helmet and a stand. The helmet includes a first half and a second half. The first half has a first pair of plates extending from an inner surface thereof and the second half of the helmet has a second pair of plates extending from a surface thereof. Each of the first pair of plates forms a respective notch therein and each of the second pair of plates forms a respective notch therein. Responsive to the first half of the helmet being directly attached to the second half of the helmet, the first pair of plates aligns with the second pair of plates thereby forming a pair of brackets. The first of the brackets has a first bracket opening formed by the notch of a first one of the first pair of plates and the notch of a first one of the second pair of plates. The second of the brackets has a second bracket opening formed by the notch of a second one of the first pair of plates and the notch of a second and of the second pair of plates. The stand includes a body and a coupling mechanism extending from a top end surface of the body. The coupling mechanism includes a first deflectable arm having a first locking tab and an opposing second deflectable arm having a second locking tab. The first locking tab is configured to directly engage the first bracket opening of the first bracket and the second locking tab is configured to directly engage the second bracket opening of the second bracket, such that the coupling mechanism aids in rigidly coupling the helmet to the stand.

According to some implementations of the present disclosure, a method of assembling a novelty helmet assembly includes providing a helmet having a first half and a second half. The first half of the helmet includes a first pair of plates extending from an inner surface thereof and the second half of the helmet includes a second pair of plates extending from an inner surface thereof. Each of the first pair of plates form a respective notch therein and each of the second pair of plates forms a respective notch therein. The first half of the helmet is attached to the second half of the helmet such that the first pair aligns with the second pair of plates thereby forming a pair of brackets. A first of the brackets has a first bracket opening formed by the notch of a first one of the first pair of plates and the notch of a first one of the second pair of plates. A second of the brackets has a second bracket opening formed by the notch of a second one of the first pair of plates and the notch of a second one of the second pair of plates. A stand is provided that includes a body and a coupling mechanism extending from a top end surface of the body. The coupling mechanism includes a first deflectable arm having a first locking tab and an opposing second deflectable arm having a second locking tab. The helmet is coupled to the stand, including (i) engaging the first bracket with the first deflectable arm and engaging the second bracket with the second deflectable arm; (ii) causing, via the pair of brackets, the first and the second deflectable arms to deflect relative to the top end surface of the body; and (iii) directly engaging the first locking tab of the first deflectable arm with the first bracket opening of the first bracket and directly engaging the second locking tab of the second deflectable arm with the second bracket opening of the second bracket.

These and other aspects of the present disclosure will become more apparent from the following detailed description of the systems and methods in conjunction with the accompanying drawings.

### BRIEF DESCRIPTION OF THE DRAWINGS

FIG. 1A is an assembled perspective view of a novelty helmet assembly according to some implementations of the present disclosure;

FIG. 1B is an exploded perspective view of the novelty helmet assembly of FIG. 1A;

FIG. 2A is an exploded perspective view of a portion of the helmet of the novelty helmet assembly of FIG. 1A;

FIG. 2B is an assembled perspective view of the portion of the helmet of the novelty helmet assembly of FIG. 2A.

FIG. 3A is a perspective view of a stand of the novelty helmet assembly of FIG. 1A;

FIG. 3B is another perspective view of the stand of the novelty helmet assembly of FIG. 1A;

FIG. 3C is a detailed side view of a coupling mechanism of the stand of FIG. 3A;

FIG. 4A is a cross-sectional side view of the novelty helmet assembly of FIG. 1A;

FIG. 4B is a cross-sectional side view of a portion of the novelty helmet assembly of

FIG. 4A;

FIG. 4C is another cross-sectional side view of a portion of the novelty helmet assembly of FIG. 4A;

FIG. 4D is a cross-sectional perspective view of the novelty helmet assembly of FIG. 4A;

FIG. 5A is a cross-sectional front view of the novelty helmet assembly of FIG. 1A;

FIG. 5B is a cross-sectional perspective view of the novelty helmet assembly of FIG. 5A;

FIG. 6A is a top-perspective view of a first embodiment of a novelty helmet assembly;

FIG. 6B is a bottom-perspective view of the novelty helmet assembly of FIG. 6A;

FIG. 6C is a top plan view of the novelty helmet assembly of FIG. 6A;

FIG. 6D is a bottom plan view of the novelty helmet assembly of FIG. 6A;

FIG. 6E is a left side elevation view of the novelty helmet assembly of FIG. 6A;

FIG. 6F is a right side elevation view of the novelty helmet assembly of FIG. 6A;

FIG. 6G is a front elevation view of the novelty helmet assembly of FIG. 6A;

FIG. 6H is a back elevation view of the novelty helmet assembly of FIG. 6A;

FIG. 7A is a top-perspective view of a second embodiment of the novelty helmet assembly;

FIG. 7B is a bottom-perspective view of the novelty helmet assembly of FIG. 7A;

FIG. 7C is a top plan view of the novelty helmet assembly of FIG. 7A;

FIG. 7D is a bottom plan view of the novelty helmet assembly of FIG. 7A;

FIG. 7E is a left side elevation view of the novelty helmet assembly of FIG. 7A;

FIG. 7F is a right side elevation view of the novelty helmet assembly of FIG. 7A;

FIG. 7G is a front elevation view of the novelty helmet assembly of FIG. 7A;

FIG. 7H is a back elevation view of the novelty helmet assembly of FIG. 7A;

FIG. 8A is a top-perspective view of a third embodiment of the novelty helmet assembly;

FIG. 8B is a bottom-perspective view of the novelty helmet assembly of FIG. 8A;

FIG. 8C is a top plan view of the novelty helmet assembly of FIG. 8A;

FIG. 8D is a bottom plan view of the novelty helmet assembly of FIG. 8A;

FIG. 8E is a left side elevation view of the novelty helmet assembly of FIG. 8A;

FIG. 8F is a right side elevation view of the novelty helmet assembly of FIG. 8A;

FIG. 8G is a front elevation view of the novelty helmet assembly of FIG. 8A; and

FIG. 8H is a back elevation view of the novelty helmet assembly of FIG. 8A.

The present disclosure is susceptible to various modifications and alternative forms, and some representative implementations have been shown by way of example in the drawings and will be described in detail herein. It should be understood, however, that the inventive aspects of the disclosure are not limited to the particular forms disclosed. Rather, the disclosure is to cover all modifications, equivalents, and alternatives falling within the spirit and scope of the invention as defined by the appended claims.

### DETAILED DESCRIPTION

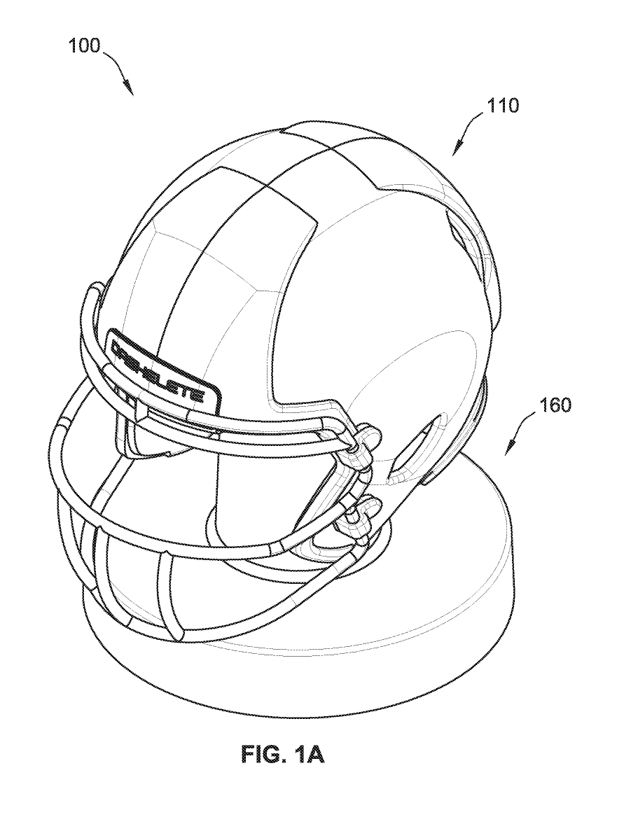

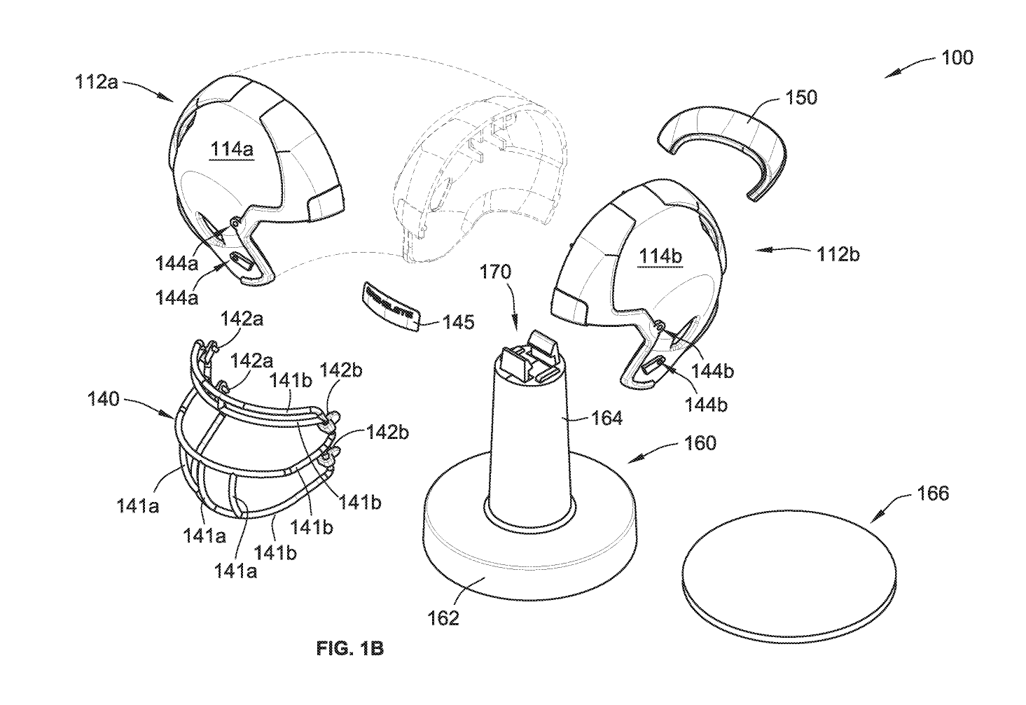

Referring generally to FIGS. 1A-1B, a novelty helmet assembly 100 includes a helmet 110 and a stand 160. As shown in FIG. 1A, the helmet 110 is rigidly coupled to the stand 160 (e.g., snapped thereto) such that the helmet 110 is prevented from moving with respect to the stand 160. The stand 160 is configured to be placed on a surface (e.g., a dashboard surface of an automobile or the like) such that the novelty helmet assembly 100 is removably or permanently mounted on the surface. As shown, the novelty helmet assembly 100 includes the helmet 110, the stand 160, a facemask 140, a decal 145, and a collar 150.

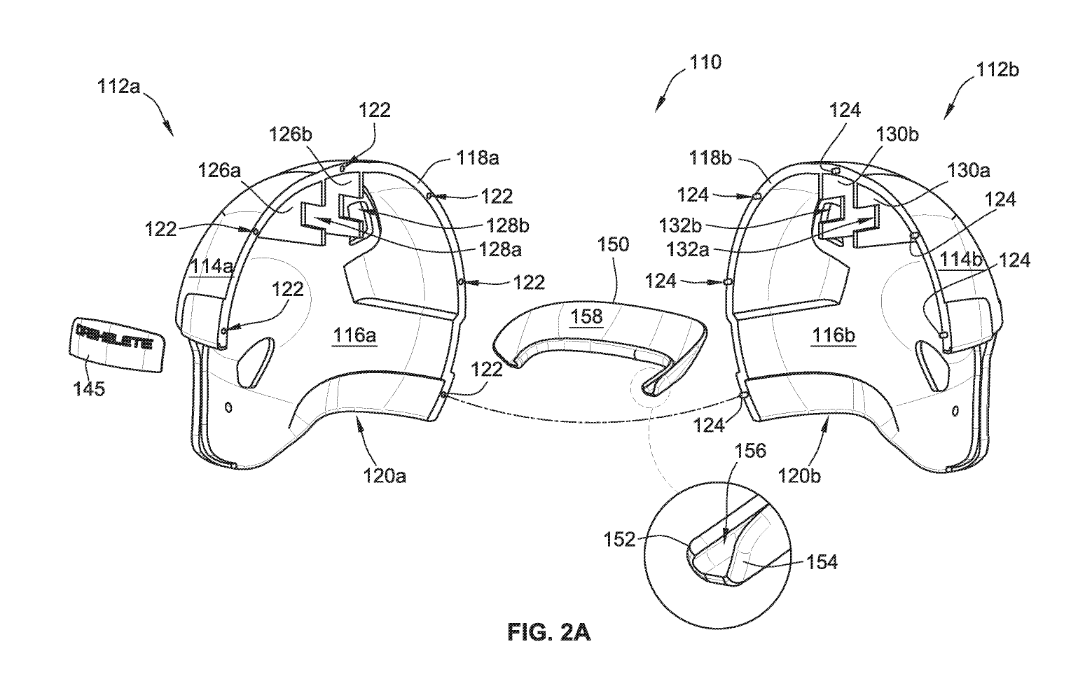

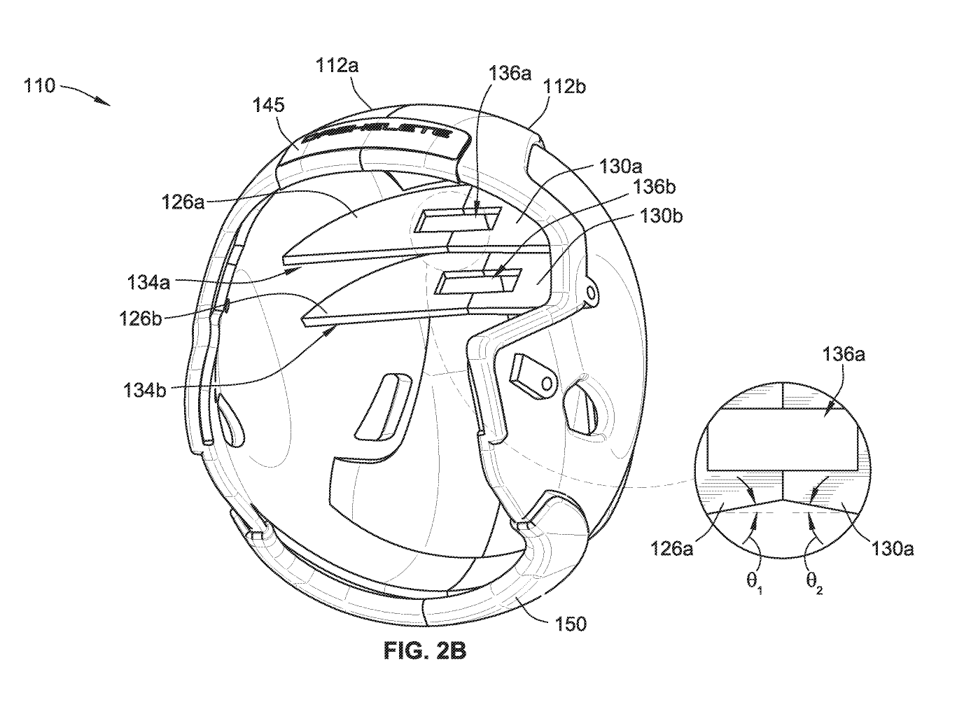

Referring generally to FIGS. 1B and 2A-2B, the helmet 110 includes a first half 112a and a second half 112b. The first half 112a includes an outer surface 114a and an inner surface 116a (FIG. 2A). Extending from the inner surface 116a are a first plate 126a and a second plate 126b. As shown, the first half 112a, the first plate 126a, and the second plate 126b are unitary and/or monolithic elements. However, other possibilities for attaching the first plate 126a and the second plate 126b to the first half 112a are contemplated, such as a welded connection (e.g., sonic welding), an adhesive or glue connection, a pin and aperture system, tabs, etc. or the like. Further, the first plate 126a has a first notch 128a and the second plate 126b has a second notch 128b. As shown, the first notch 128a and the second notch 128b each have a general “U” shape configuration although any other shape configuration is contemplated (e.g., a generally “V” shape configuration, a generally polygonal shape configuration, a generally semi-circular shape configuration, etc.). While the first half 112a is depicted as having two plates 126a, 126b, any number of plates is contemplated, such as, for example, one plate, three plates, six plates, etc.

The second half 112b of the helmet 110 is similar to the first half 112a and in some implementations is a mirror image or almost a mirror image of the first half 112a. As shown, the second half 112b includes an outer surface 114b and an inner surface 116b (FIG. 2A). Extending from the inner surface 116b are a third plate 130a and a fourth plate 130b. As shown, the second half 112b, the third plate 130a, and the fourth plate 130b are unitary and/or monolithic elements. However, other possibilities for attaching the third plate 130a and the fourth plate 130b to the second half 112b are contemplated, such as a welded connection (e.g., sonic welding), an adhesive or glue connection, a pin and aperture system, tabs, etc., or the like. Further, the third plate 130a has a third notch 132a and the fourth plate 130b has a fourth notch 132b. As shown, the third notch 132a and the fourth notch 132b each have a general “U” shape configuration although any other shape configuration is contemplated (e.g., a generally “V” shape configuration, a generally polygonal shape configuration, a generally semi-circular shape configuration, etc.). While the second half 112b is depicted as having two plates 130a, 130b, any number of plates is contemplated, such as, for example, one plate, three plates, six plates, etc.

As best shown in FIG. 2A, the first half 112a includes a first end mating surface 118a and the second half 112b includes a second end mating surface 118b. To form or assemble the helmet 110, the first half 112a is attached to the second half 112b such that the first end mating surface 118a of the first half 112a directly abuts the second end mating surface 118b of the second half 112b. For example, the first half 112a may be attached or secured to the second half 112b by a glued connection, a welded connection, a fused connection, a riveted connection, a magnetic connection, or the like, or any combination thereof. Advantageously, forming the helmet 110 with a separate first half 112a and a separate second half 112b aids in the manufacturing of the novelty helmet assembly 100 by, for example, permitting and/or simplifying the fabrication process using injection molding, compression molding, machining, 3-D printing, and the like, or any combination thereof. Alternatively, the first half 112a may be unitary and/or monolithic with the second half 112b.

The first and the second halves 112a, 112b may be made of any material or combination of materials, such as, for example, a polymer material, a fiberglass material, a metal material, a rubber material, an organic material (e.g., wood), or any other suitable material.

In some implementations, as best shown in FIG. 2A, the first half 112a is attached with the second half 112b by way of a pin and aperture coupling mechanism. The first end mating surface 118a of the first half 112a includes a plurality of apertures 122 that are generally evenly spaced along the first end mating surface 118a. The second end mating surface 118b of the second half 112b includes a plurality of pins 124 that are sized, shaped, and positioned along the second end mating surface 118b to engage corresponding ones of the plurality of apertures 122. Engaging the plurality of pins 124 and plurality of apertures 122 aids in the maintaining of the attachment of the first half 112a with the second half 112b. Once engaged, the plurality of pins 124 is generally secured by a friction fit and/or a press fit between the plurality of pins 124 and the plurality of apertures 122. Other methods of securing the plurality of pins 124 and plurality of apertures 122 are contemplated, such as a snap-in connection, a tapered connection, a threaded connection, a glued connection, a magnetic connection, or the like, or any combination thereof. While the plurality of apertures 122 and the plurality of pins 124 are each depicted as having six apertures and six corresponding pins, any number of apertures and pins is contemplated, such as, for example, one aperture and one pin, two apertures and two pins, four apertures and four pins, ten apertures and ten pins, etc.

As best shown in FIG. 1B, the novelty helmet assembly 100 includes the facemask 140, which includes a first plurality of pins 142a and a second plurality of pins 142b. The first half 112a of the helmet 110 has a first plurality of apertures 144a and the second half 112b of the helmet 110 has a second plurality of apertures 144b. The first plurality of pins 142a of the facemask 140 is configured to engage the first plurality of apertures 144a of the first half 112a and the second plurality of pins 142b of the facemask 140 is configured to engage the second plurality of apertures 144b of the second half 112b in order to couple the facemask 140 to the helmet 110. While the plurality of pins 142a, 142b are shown as being two pins, and the plurality of apertures 144a, 144b are shown as being two apertures, any number of pins 142a, 142b and apertures 144a, 144b is contemplated, such as, for example, four pins 142a, 142b and four apertures 144a, 144b, etc. Attaching the facemask 140 to the helmet 110, as shown in FIG. 1A, can aid in maintaining the attachment of the first half 112a and the second half 112b. The helmet 110 and the facemask 140 can be made of the same material and/or a combination of different materials. For example, the helmet 110 can be made of a plastic material and the facemask 140 can be made of a metal material.

The facemask 140 includes a plurality of vertical members 141a and a plurality of horizontal members 141b. While the plurality of vertical members 141a is shown as being three vertical members 141a and the plurality of horizontal members 141b is shown as being four horizontal members 141b, any number of horizontal members 141b and vertical members 141a is contemplated, such as, for example, zero vertical members and three horizontal members, four vertical members and four horizontal members, etc. Additionally, the facemask 140 may include a transparent or semi-transparent visor (not shown) secured between a first one of the plurality of horizontal members and a second one of the plurality of horizontal members.

In some implementations, the novelty helmet assembly 100 includes the decal 145. As shown in FIGS. 1A and 2B, the decal 145 is coupled to the outer surface 114a of the first half 112a and the outer surface 114b of the second half of the helmet 112b. Coupling the decal 145 to the helmet 110 can aid in maintaining the attachment of the first half 112a with the second half 112b. The decal 145 may be made of the same material as the helmet 110 and/or a combination of different materials. The decal 145 can be coupled to the outer surface 114a of the first half 112a and the outer surface 114b of the second half 112b by, for example, a snap fit, a pin and aperture system, an adhesive or glue connection, a welded connection, a magnetic connection, a riveted connection, or the like, or any combination thereof. In some implementations, the decal 145 is a sticker with an adhesive backing that is applied to the helmet 110.

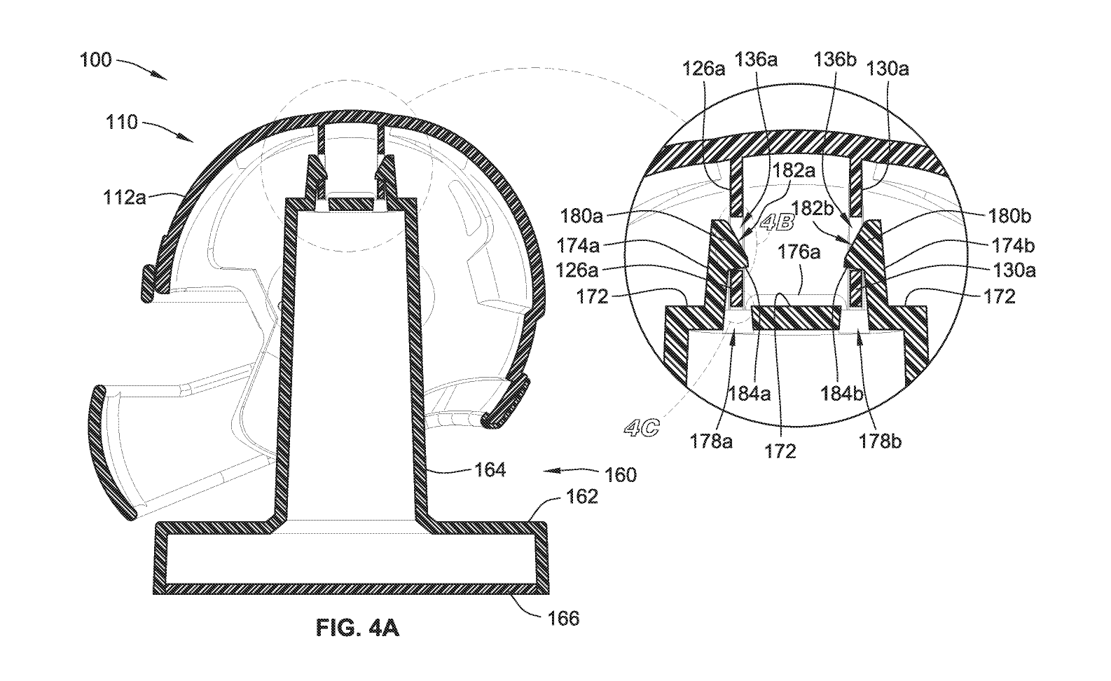

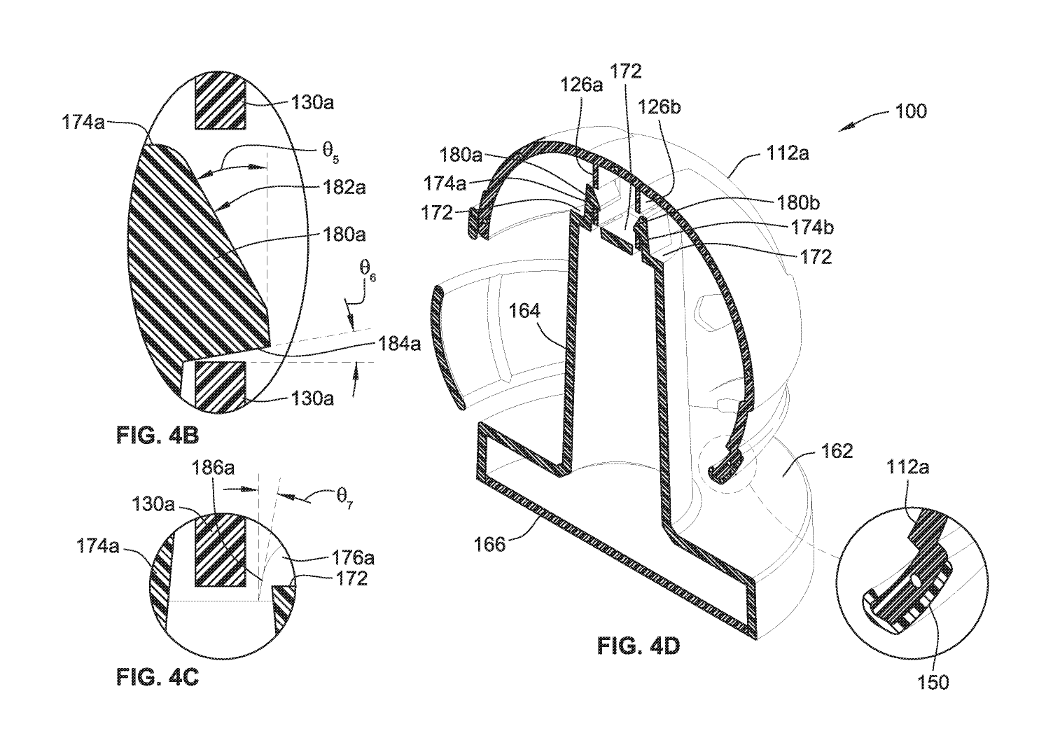

As best shown in FIG. 2A, the novelty helmet assembly 100 includes the collar 150. Coupling the collar 150 to the helmet 110, as shown in FIG. 2B, can aid in maintaining the attachment of the first half 112a with the second half 112b. The first half 112a of the helmet 110 has a rear edge surface 120a (FIG. 2A) and the second half 112b of the helmet 110 has a rear edge surface 120b (FIG. 2A). The collar 150 has an inner portion 152 and an outer portion 154. The inner portion 152 and outer portion 154 define a groove 156 therebetween that is sized and shaped to correspond with the size and shape of the rear edge surfaces 120a, 120b. As best shown in FIG. 4D, the collar 150 is coupled to the helmet 110 such that the groove 156 engages (e.g., directly) the rear edge surface 120a of the first half 112a and the rear edge surface 120b of the second half 112b. The inner portion 152 of the collar 150 engages the inner surface 116a (FIG. 2A) of the first half 112a and inner surface 116b (FIG. 2A) of the second half 112b, and the outer portion 154 of the collar 150 engages the outer surface 114a (FIG. 1B) of the first half 112a and outer surface 114b (FIG. 1B) of the second half 112b. As such, the collar 150 is generally secured by a snap fit between the groove 156 and the rear edge surfaces 120a, 120b. However, other methods of securing the collar 150 are contemplated, such as an adhesive or glue connection, a welded connection, a pin and aperture system, a tab connection, or any combination thereof. The collar 150 can be made of the same material as the helmet 110 and/or one or more different materials.

Referring to FIG. 2B, the first half 112a is attached to the second half 112b in order to form the helmet 110. As shown, the decal 145 and the collar 150 are both coupled to the first half 112a and the second half 112b to aid in maintaining the attachment thereof In this assembled/attached configuration of the helmet 110, the first plate 126a of the first half 112a directly abuts the third plate 130a of the second half 112b, thereby forming a first bracket 134a.

The first bracket 134a has a first bracket opening 136a formed by the first notch 128a (FIG. 2A) of the first plate 126a and the third notch 132a (FIG. 2A) of the third plate 130a. Similarly, the second plate 126b of the first half 112a directly abuts the fourth plate 130b of the second half 112b, thereby forming a second bracket 134b. The second bracket 134b has a second bracket opening 136b formed by the second notch 128b (FIG. 2A) of the second plate 126b and the fourth notch 132b (FIG. 2A) of the fourth plate 130b.

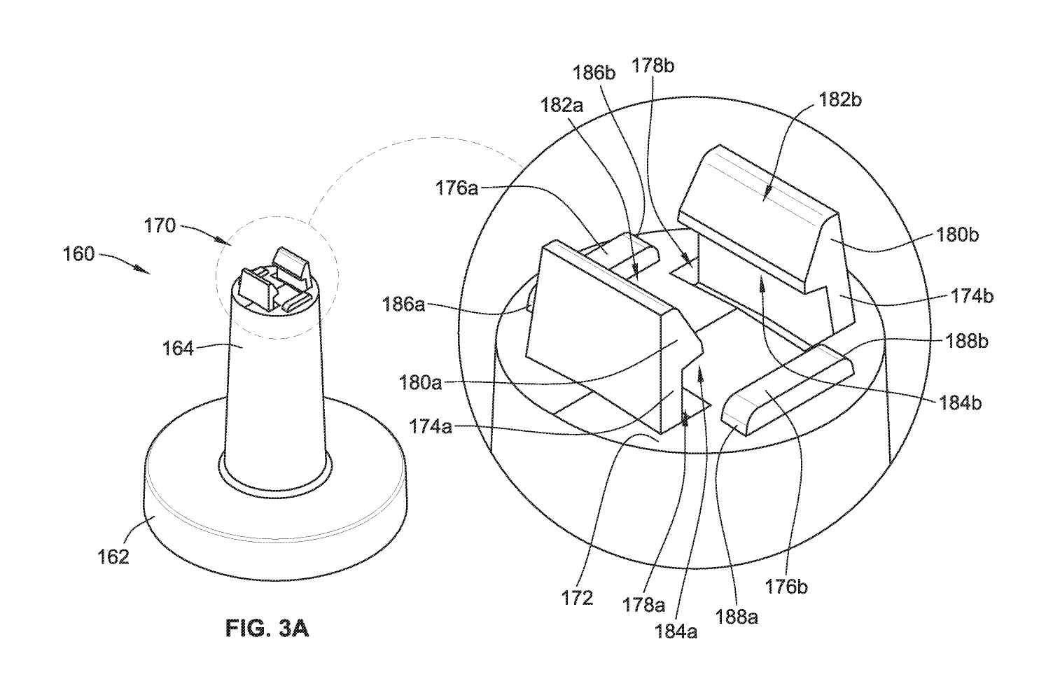

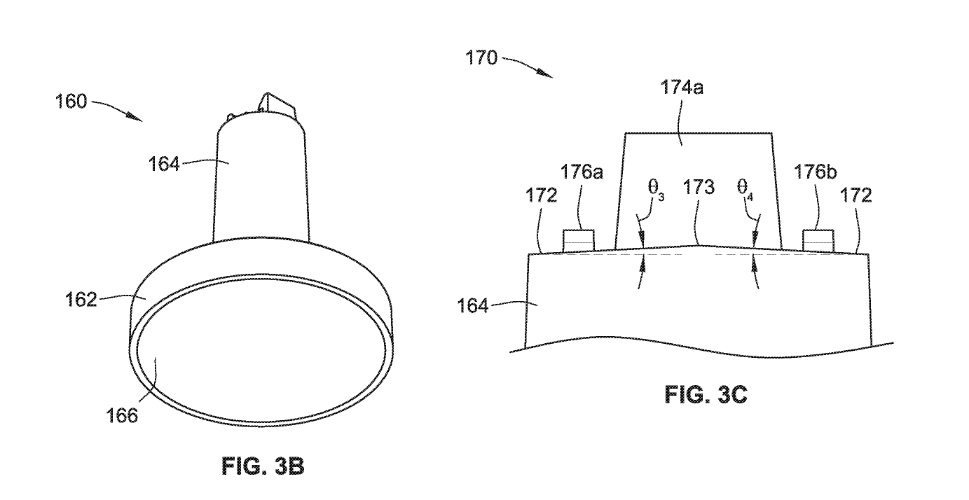

As depicted, in some implementations, the first plate 126a, the second plate 126b, the third plate 130a, and the fourth plate 130b each have a tapered bottom surface. As best shown in FIG. 2B, the first plate 126a may be tapered by an angle θ₁ and the third plate 130a may be tapered by an angle θ₂. While θ₁ and θ₂ are both depicted as approximately ten degrees, other values for θ₁ and θ₂ are contemplated, such as, for example, fifteen degrees, thirty degrees, forty-five degrees, etc. As such, the tapered bottom surfaces of the first plate 126a and the third plate 130a form an inwardly tapered bottom surface of the first bracket 134a. The inwardly tapered bottom surface of the first bracket 134a is configured to aid in aligning the first bracket 134a with a coupling mechanism 170 (FIG. 3A) of the stand 160 during assembly of the novelty helmet assembly 100.

Similarly, the second plate 126b and the fourth plate 130b may each have a tapered bottom surface, each of which is tapered by an angle. The angles of the tapered bottom surfaces of the second plate 126b and the fourth plate 130b are the same as or similar to the angles θ₁ and θ₂ of the tapered bottom surfaces of the first plate 126a and the third plate 130a. As such, the tapered bottom surfaces of the second plate 126b and the fourth plate 130b form an inwardly tapered bottom surface of the second bracket 134b. The inwardly tapered bottom surface of the second bracket 134b is configured to aid in aligning the second bracket 134b with the coupling mechanism 170 (FIG. 3A) of the stand 160 during assembly of the novelty helmet assembly 100.

During the coupling of the helmet 110 to the stand 160, the stand 160 imparts a force on the first bracket 134a that may urge the first plate 126a and the third plate 130a to separate and/or move relative to one another. Similarly, the stand 160 imparts a force on the second bracket 134b that may urge the second plate 126b and the fourth plate 130b to separate and/or move relative to one another. Because the brackets 134a, 134b are formed by the plates, separation or movement of the plates may cause the brackets to disengage the coupling mechanism 170 and/or generally loosen the coupling between the helmet 110 and the stand 160. Thus, in some implementations, the first plate 126a can be secured to the third plate 130a and the second plate 126b can be secured to the fourth plate 130b via respective coupling mechanisms (not shown) to aid in maintaining the rigidity and structural integrity of the first bracket 134a and the second bracket 134b.

In some implementations, during the attachment of the first half 112a with the second half 112b, the first plate 126a is attached to the third plate 130a and the second plate 126b is attached to the fourth plate 130b to aid in strengthening the connection between the first plate 126a and the third plate 130b and the connection between the second plate 126b and the fourth plate 130b. Additionally, this configuration further aids in maintaining the attachment between the first half 112a and second half 112b. Various methods of attaching or coupling the plates together are contemplated, such as, for example, a clip, an adhesive or glue connection, a welded connection, a fused connection, a magnetic connection, a pin and aperture system, or the like, or any combination thereof.

In some implementations, a first clip (not shown) can be attached to the first plate 126a and the third plate 130a to strengthen the attachment of the first plate 126a and the third plate 130a. In such implementations, the first clip can be secured to the first plate 126a and the third plate 130a via an adhesive or glue connection, a welded connection, a fused connection, a magnetic connection, a press fit, a snap fit, or the like, or any combination thereof. The first clip, the first plate 126a, and the third plate 130a can be made of the same material and/or a combination of different materials. For example, the first plate 126a and the third plate 130a can be made of a polymer material and the first clip can be made of a metal material. The first clip aids in preventing the first plate 126a and the third plate 130a from separating and/or moving relative to one another. Thus, the first clip aids in increasing the rigidity and structural integrity of the first bracket 134a, in particular, during the coupling of the helmet 110 to the stand 160. Additionally, this configuration further aids in maintaining the attachment between the first half 112a and second half 112b.

A second clip (not shown) can also be attached to the second plate 126b and the fourth plate 130b to strengthen the attachment of the second plate 126b and the fourth plate 130b in the same, or similar, manner as the first clip described above.

The size and shape of the first bracket opening 136a is generally dependent upon the size and shape of the first notch 128a and the third notch 132a. Likewise, the size and shape of the second bracket opening 136b is dependent upon the size and shape of the second notch 128b and fourth notch 132b. For example, as shown, each notch has a generally “U” shaped configuration such that the first bracket opening 136a and second bracket opening 136b each has a generally rectangular shape. Alternatively, the notches may have a generally semi-circular shape such that the first bracket opening 136a and second bracket opening 136b have a generally circular shape, a generally semi-elliptical shape such that the first bracket opening 136a and second bracket opening 136b have a generally elliptical shape, a generally triangular or “V” shape configuration such that the first bracket opening 136a and second bracket opening 136b have a diamond-like shape, etc.

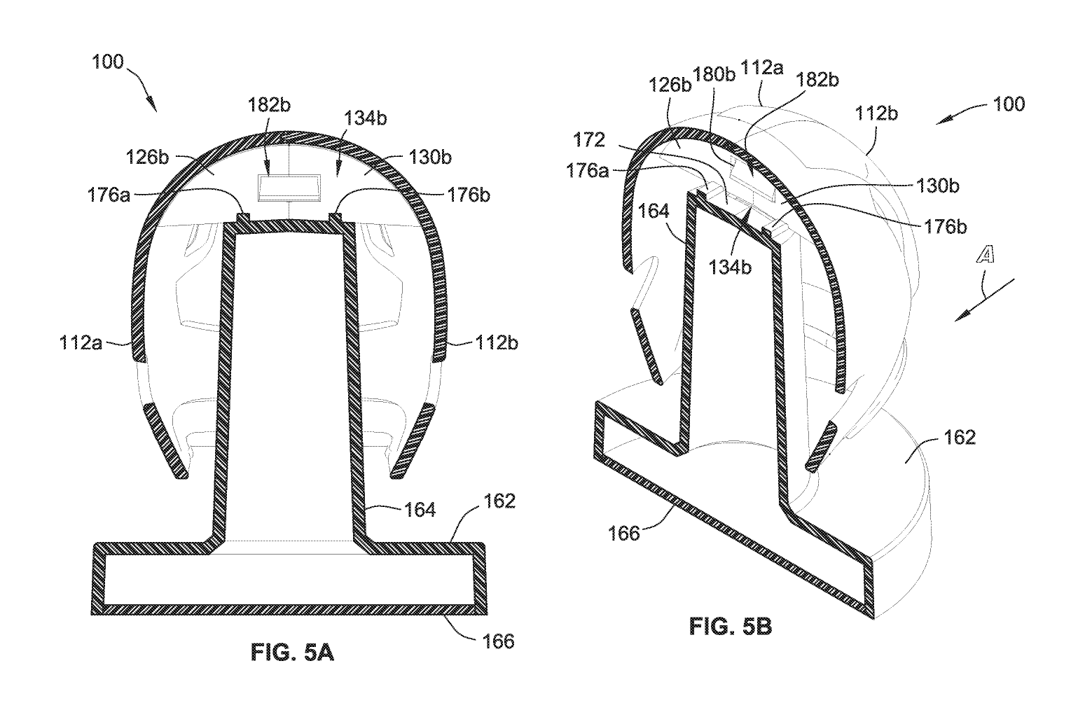

Referring generally to FIGS. 3A-5B, the stand 160 includes a base portion 162, a stem 164, and a coupling mechanism 170. As best shown in FIGS. 4A-5B, the stand 160 has a hollow cross-section although the stand 160 can be solid. Further, the base portion 162, the stem 164, and the coupling mechanism 170 are unitary and/or monolithic elements; however, the base portion 162, the stem 164, and the coupling mechanism 170 can be separate and distinct elements that are attached via a welded connection, an adhesive or glue connection, a pin and aperture system, tabs, or the like, or any combination thereof. The helmet 110, the base portion 162, the stem 164, and the coupling mechanism 170 can be made of the same material and/or a combination of different materials.

As best shown in FIGS. 3A-3C, the base portion 162 has a generally cylindrical configuration. Alternatively, the base portion 162 may have any other configuration, as such, for example, a rectangular configuration, a triangular configuration, an oval configuration, a semi-circular configuration, and/or a polygonal configuration. Referring to FIGS. 1B and 3C, the base portion 162 includes a bottom lid 166. The bottom lid 166 is sized and shaped such that it may be attached to and partially disposed within the base portion 162 (FIGS. 4A-5B). While shown in a generally cylindrical configuration, the bottom lid 166 may alternatively have any other configuration that corresponds to the configuration of the base portion 162.

The bottom lid 166 is configured to aid in preventing the novelty helmet assembly 100 from moving relative to a surface upon which the novelty helmet assembly 100 is placed. For example, the novelty helmet assembly 100 may be placed on a vehicle dashboard, a desk top, a counter, a table, a shelf, or the like. In this configuration, friction between the bottom lid 166 and the surface prevents the novelty helmet assembly 100 from tipping over or moving relative to the surface. To aid in engaging the novelty helmet assembly 100 with the surface and preventing movement therebetween, the bottom lid 166 may include, have, or be configured to include/have a sticky layer, a glue layer, a silicone layer, a high friction layer, a hook and loop fastener, a magnet, a suction cup, or any combination thereof.

Referring generally to FIGS. 3A-5B, the stem 164 of the stand 160 extends from the base portion 162. As depicted, the stem 164 has a generally cylindrical configuration with a diameter that is less than a diameter of the base portion 162. Alternatively, the stem 164 may have any other configuration, such as, for example, a rectangular configuration, a triangular configuration, an oval configuration, a semi-circular configuration, and/or a polygonal configuration. In some implementations, the diameter of the stem 164 may be substantially equal to the diameter of the base portion 162. Further, the stem 164 is generally sized and shaped such that it can be at least partially disposed within the helmet 110 (FIGS. 4A-5B) and such that the coupling mechanism 170 can reach and engage the first and the second brackets 134a, 134b.

As best shown in FIG. 3A, the coupling mechanism 170 extends from the top end surface 172 of the stem 164. As best shown in FIGS. 4A-5B, the coupling mechanism 170 is configured to rigidly couple the helmet 110 to the stand 160, thereby preventing movement of the helmet 110 relative to the stand 160.

In some implementations, the top end surface 172 is outwardly tapered relative to horizontal such that a central peak 173 is formed at a center of the top end surface 172, as best shown in FIG. 3C. Specifically, a first half of the top end surface 172 has an angle, θ₃, relative to horizontal on a first side of the central peak 173 and a second opposing half of the top end surface 172 has an angle, θ₄, relative to horizontal on a second side of the central peak 173. While the angles, θ₃ and θ₄ are shown as being approximately ten degrees, other values for θ₃ and θ₄ are contemplated, such as, for example, fifteen degrees, thirty degrees, forty-five degrees, etc. As described above, each plate that forms the first bracket 134a and the second bracket 134b may have an inwardly tapered surface. For example, referring back to FIG. 2B, the angle θ₁ of the bottom surface of the first plate 126a and the angle of the bottom surface of the second plate 126b can correspond to the angle θ₃ of the first half of the top end surface 172. As shown in FIGS. 2B and 3C, θ₁ is substantially equal to θ₃ (both are shown as approximately ten degrees). Thus, the inwardly tapered bottom surfaces of the plates 126a, 130a can fully engage the outwardly tapered top end surface 172. Similarly, the angle θ₂ of the bottom surface of the third plate 130a and the angle of the bottom surface of the fourth plate 130b can correspond to the angle θ₄ of the second half of the top end surface 172. As shown in FIGS. 2B and 3C, θ₂ is substantially equal to θ₄ (both as shown as approximately ten degrees). Thus, the inwardly tapered surfaces of the plates 126b, 130b can fully engage the outwardly tapered top end surface 172. As best shown in FIG. 5A, these corresponding angles allow the first bracket 134a (not shown in FIG. 5A) and the second bracket 134b to fully engage the top end surface 172, which aids in rigidly coupling the helmet 110 to the stand 160. As best shown in FIG. 3A, the coupling mechanism 170 includes a first deflectable arm 174a and a second deflectable arm 174b. The first deflectable arm 174a and the second deflectable arm 174b are generally biased inward towards one another such that when a force being applied to separate the first deflectable arm 174a from the second deflectable arm 174b is removed, the first deflectable arm 174a and the second deflectable arm 174b generally spring back towards one another. The first deflectable arm 174a includes a first locking tab 180a having a first angled surface 182a and a first undercut 184a. Similarly, the second deflectable arm 174b includes a second locking tab 180b having a second angled surface 182b and a second undercut 184b. The first locking tab 180a is configured to directly engage the first bracket opening 136a of the first bracket 134a and the second locking tab 180b is configured to directly engage the second bracket opening 136b of the second bracket 134b as shown in FIGS. 4A-5B. As such, the first locking tab 180a and the second locking tab 180b are sized and shaped to generally correspond to the size and shape of the first bracket opening 136a and the second bracket opening 136b.

During assembly of the novelty helmet assembly 100, the first angled surface 182a of the first locking tab 180a and the second angled surface 182b of the second locking tab 180b are positioned to initially engage the leading edges or surfaces of the first and the second brackets 134a, 134b. The angled surfaces 182a, 182b aid in the initial engagement of the helmet 110 and the stand 160 and also aid in facilitating the outward deflecting of the first deflectable arm 174a and the second deflectable arm 174b relative to each other. As best shown in FIG. 4B, the first angled surface 182a has an angle, θ₅, that is approximately thirty degrees relative to vertical. It is contemplated that the angle θ₅ can be any other angle, such as, for example, ten degrees, twenty degrees, forty-five degrees, sixty degrees, etc. The second angled surface 182b also has an angle relative to vertical which is the same as, or similar to, the angle θ₅ of the first angled surface 182a.

In some implementations, assembly of the novelty helmet assembly 110 is achieved by forming the helmet 110 and coupling the assembled helmet 110 to the stand 160. In such a method, initially, the first bracket 134a engages the first angled surface 182a of the first deflectable arm 174a and the second bracket 134b engages the second angled surface 182b of the second deflectable arm 174b. As the leading edges or surfaces of the brackets 134a, 134b move and/or slide along the respective angled surfaces 182a, 182b and towards the top end surface 172 of the stem 164, the first deflectable arm 174a and second deflectable arm 174b deflect outward away from one another. Once the leading edges or surfaces of the brackets 134a, 134b and the bottom edges or surfaces of the bracket openings 136a, 136b are moved past the angled surfaces 182a, 182b, the tips of the locking tabs 180a, 180b protrude into the bracket openings 136a, 136b such that the deflectable arms 174a, 174b spring back towards one another. The locking tabs 180a, 180b then directly engage the bracket openings 136a, 136b such that the brackets 134a, 134b are secured against the deflectable arms 174a, 174b and the top end surface 172. Thus, the helmet 110 is rigidly coupled to the stand 160 such that the helmet 110 is inhibited or prevented from moving relative to the stand 160.

As best shown in FIGS. 3A and 4A, the coupling mechanism 170 includes a first slot 178a positioned directly adjacent to the first deflectable arm 174a and a second slot 178b positioned directly adjacent to the second deflectable arm 174b. The first slot 178a and the second slot 178b further can aid in permitting the first deflectable arm 174a and second deflect arm 174b to deflect relative to the top end surface 172 of the stem 164.

As best shown in FIG. 4A, the first undercut 184a of the first locking tab 174a and the second undercut 184b of the second locking tab 174b are configured to directly engage the first bracket opening 136a and the second bracket opening 136b. Referring to FIG. 4B, in some implementations, the first undercut 184a has an angled or tapered surface defined by an angle θ₆, which is shown as approximately ten degrees. However, other values for θ₆ are contemplated, such as, for example, ten degrees, twenty degrees, forty-five degrees, sixty degrees, etc. The first undercut 184a permits at least a portion of the first locking tab 180a to be disposed within the first bracket opening 136a while securing the first bracket 134a against the first deflectable arm 174a.

Similarly, the second undercut 184b (FIG. 4A) has an angled or tapered surface defined by an angle, which is the same as, or similar to, the angle θ₆ of the first undercut 184a. The second undercut 184b permits at least a portion of the second locking tab 180b to be disposed within the second bracket opening 136b while securing the second bracket 134b against the second deflectable arm 174b.

The coupling mechanism 170 further includes a first alignment protrusion 176a and a second alignment protrusion 176b, each extending from the top end surface 172 of the stem 164. The first alignment protrusion 176a and the second alignment protrusion 176b are configured to aid in aligning the first bracket 134a with the first deflectable arm 174a and aligning the second bracket 134b with the second deflectable arm 174b during assembly of the helmet 110 with the stand 160. The first alignment protrusion 176a has a first angled end 186a and an opposing second angled end 186b. As best shown in FIG. 4C, the first angled end 186a of the first alignment protrusion 176a is defined by an angle θ₇, which is shown as approximately forty-five degrees. However, other values for θ₇ are contemplated, such as, for example, ten degrees, twenty degrees, forty-five degrees, sixty degrees, etc. The second angled end 186b of the first alignment protrusion 176a is the same as, or similar to, the first angled end 186a. Each angled end 186a, 186b of the first alignment protrusion 176a is configured to aid in moving the brackets 134a, 134b past the first alignment protrusion 176a such that the bottom surface of the brackets engage the top end surface 172 during assembly. Alternatively, in some implementations, the first alignment protrusion 176a has a first curved end and an opposing second curved end. In other implementations, the first alignment protrusion 176a has both a first angled and curved end and a second angled and curved end.

Similarly, the second alignment protrusion 176b has a first angled end 188a and an opposing second angled end 188b as shown in FIG. 3A. The first angled end 188a is defined by an angle that is the same as, or similar to, the angle θ₇ of the first angled end 186a of the first alignment protrusion 176a. The second angled end 188b is the same as, or similar to, the first angled end 188a. Each angled end 188a, 188b of the second alignment protrusion 176b is configured to aid in moving the brackets 134a, 134b past the second alignment protrusion 176b such that the bottom surface of the brackets engage the top end surface 172 during assembly. Alternatively, in some implementations, the second alignment protrusion 176b has a first curved end and an opposing second curved end. In other implementations, the second alignment protrusion 176b has both a first angled and curved end and a second angled and curved end.

The first alignment protrusion 176a and the second alignment protrusion 176b may also further aid in securing the first bracket 134a to the first deflectable arm 174a and the second bracket 134b to the second deflectable arm 174b. As best shown in FIG. 5B, the first alignment protrusion 176a and the second alignment protrusion 176b aid in preventing movement of the second bracket 134b relative to the second deflectable arm 174b in the direction of arrow A. To prevent movement of the brackets 134a, 134b relative to the coupling mechanism 170, the first alignment protrusion 176a and the second alignment protrusion 176b are spaced from the deflectable arms 174a, 174b at a distance that is substantially equal to the width of the brackets 134a, 134b. As such, there is little or no space (e.g., less than 0.2 inches, less than 0.1 inches, less than 0.05 inches, less than 0.01 inches, etc.) between the deflectable arms 174a, 174a and the brackets 134a, 134b and between the alignment protrusions 176a, 176b and the brackets 134a, 134b. The alignment protrusions 176a, 176b thus aid in maintaining the attachment of the helmet 110 to the stand 160 and inhibit or prevent movement of the helmet 110 relative to the stand 160.

As described above, the base portion 162 and the stem 164 of the stand 160 may be hollow. The thickness of the stand 160 corresponds to the desired structural integrity and durability of the stand 160. Advantageously, the hollow base portion 162 and stem 164 permit a user to disassemble the novelty helmet assembly 100 for storage, transportation, or maintenance. In such an implementation, the bottom lid 166 may be removed, exposing the interior of the base portion 162 and stem 164. The user may then place a pin or similarly shaped object (e.g. a paperclip) in the first slot 178a and the second slot 178b of the locking mechanism 170 to thereby disengage the first locking tab 180a and first bracket opening 136a and the second locking tab 180b and the second bracket opening 136b. Upon disassembly, the novelty helmet assembly 100 may be reassembled by the user using the same methods as described above.

Alternatively, the stand 160 may be a solid component. In such a configuration, a user may disassemble the novelty helmet assembly 100 by reaching the coupling mechanism 170 through a space between the helmet 110 and the facemask 140. Alternatively, the facemask 140 may be removed to facilitate access to the coupling mechanism 170. Advantageously, the added weight from the stand 160 being solid further aids in securing the novelty helmet assembly 100 to a surface, as discussed above.

While the helmet 110 is depicted in FIGS. 1A-5B as having a football helmet configuration, other types of sporting or recreational helmet configurations are contemplated, such as, for example, a baseball helmet, a hockey helmet, a lacrosse helmet, a biking helmet, a motorcycle helmet, a racing helmet, a cricket helmet, a horseback riding helmet, a fencing helmet, or the like. Further, other types of helmet configurations are contemplated, such as, for example, a construction helmet, a police helmet, a mining helmet, a military helmet, or the like.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the invention. It is also contemplated that additional embodiments according to aspects of the present invention may combine any number of features from any of the embodiments described herein.

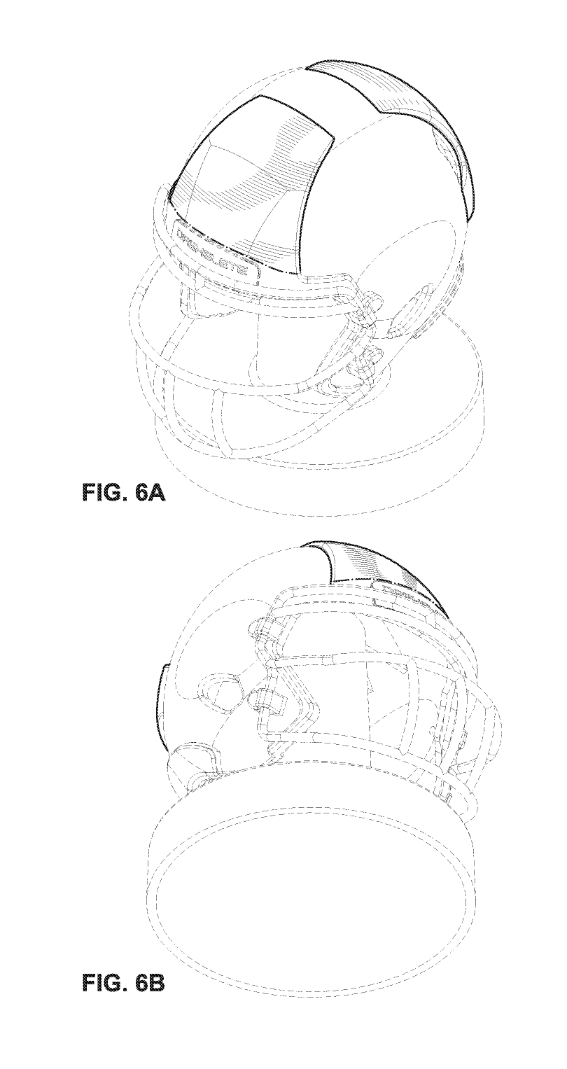

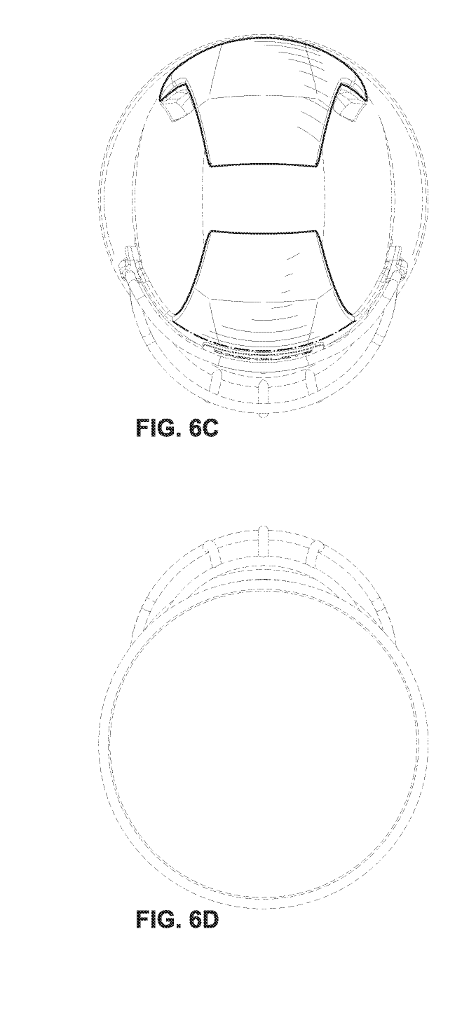

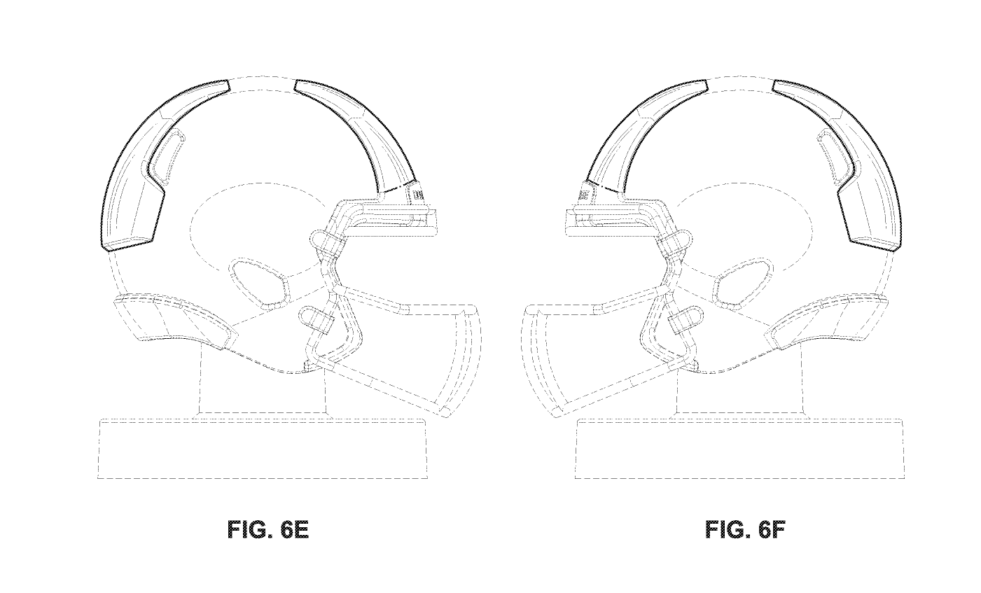

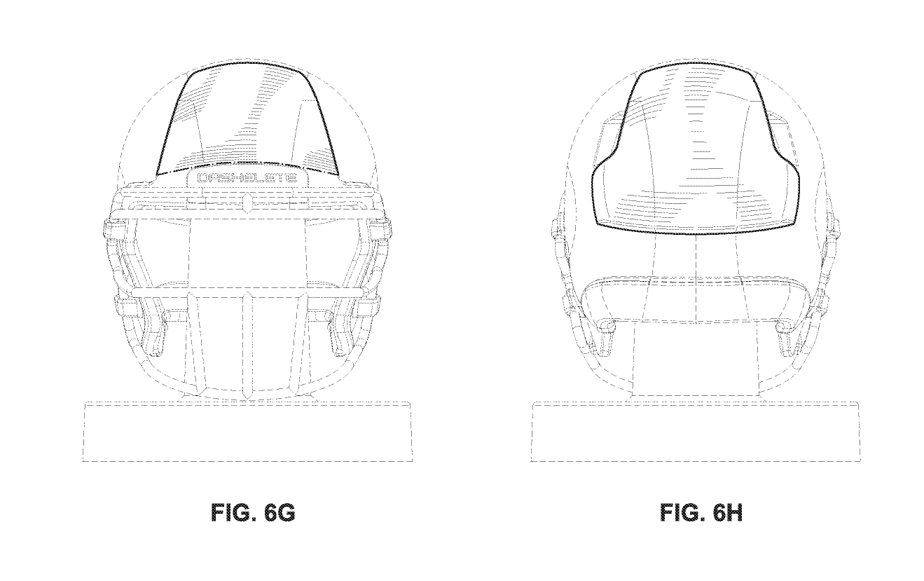

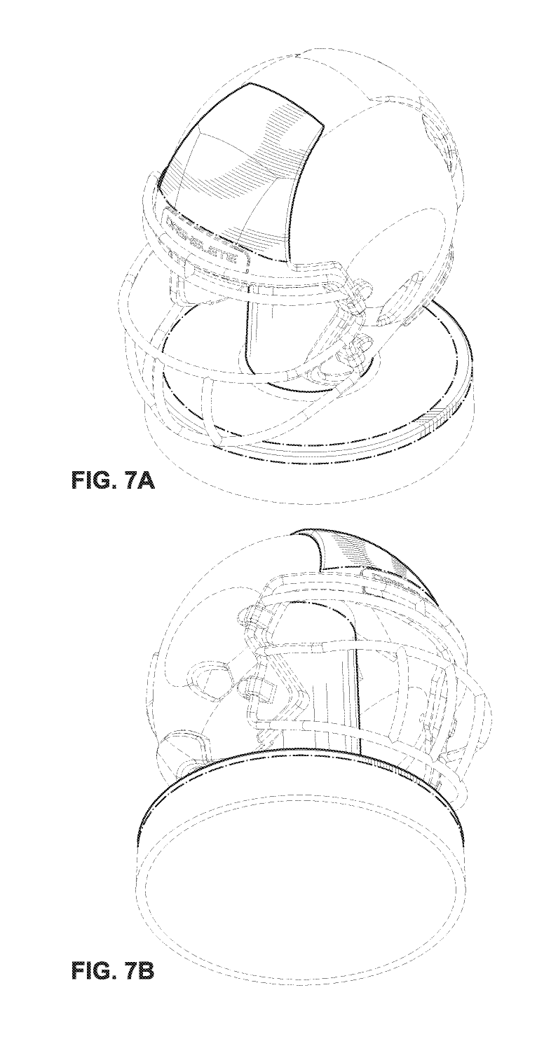

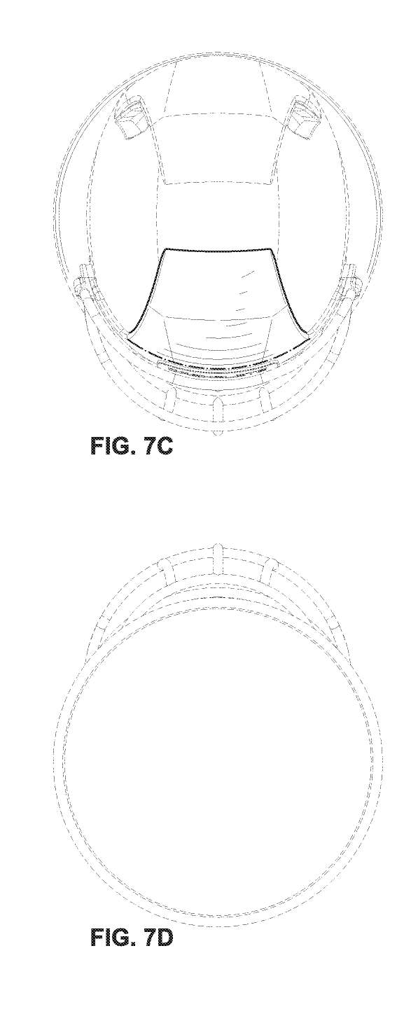

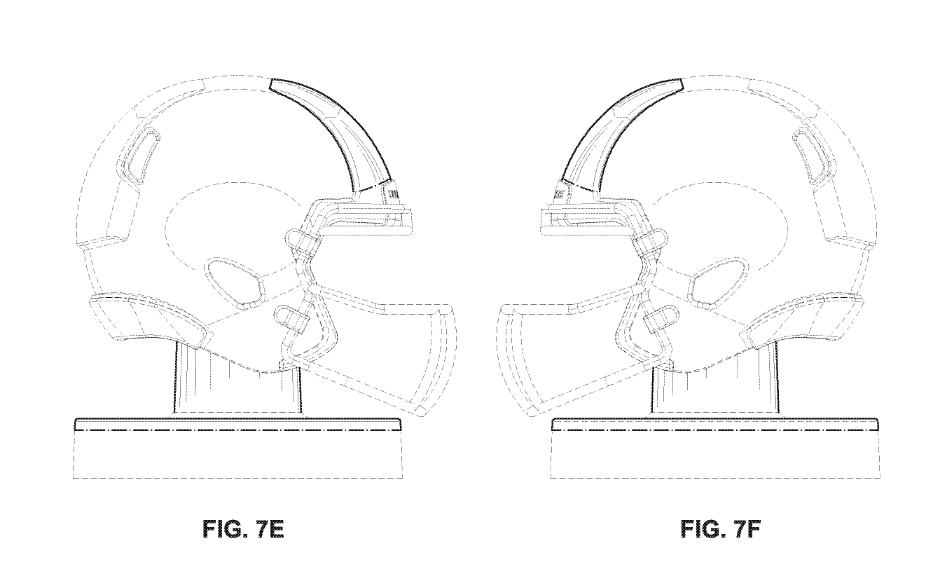

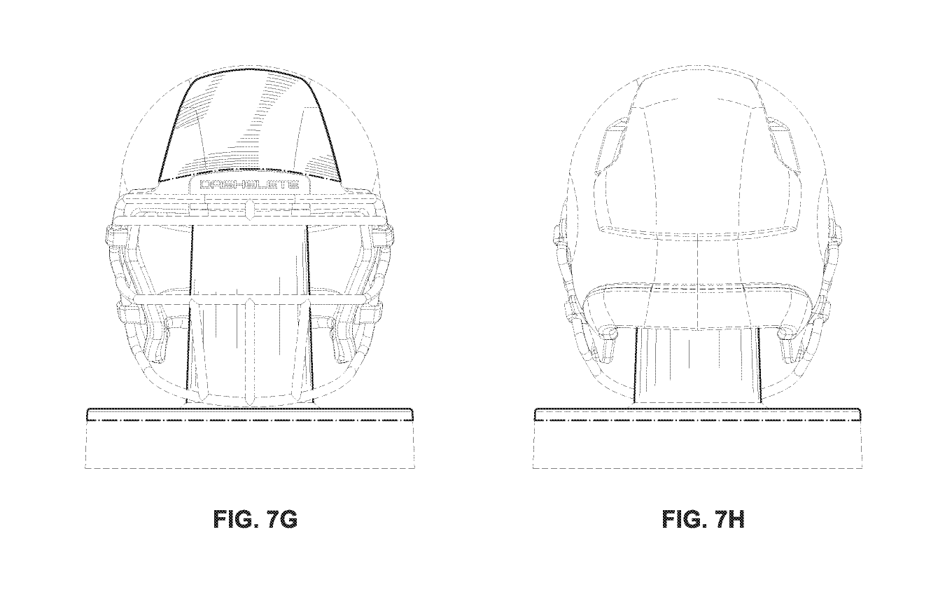

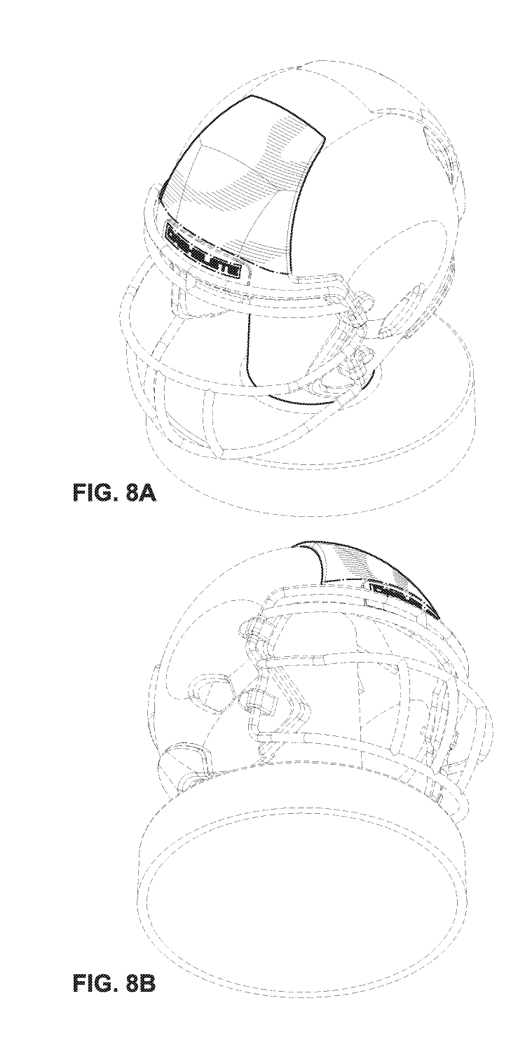

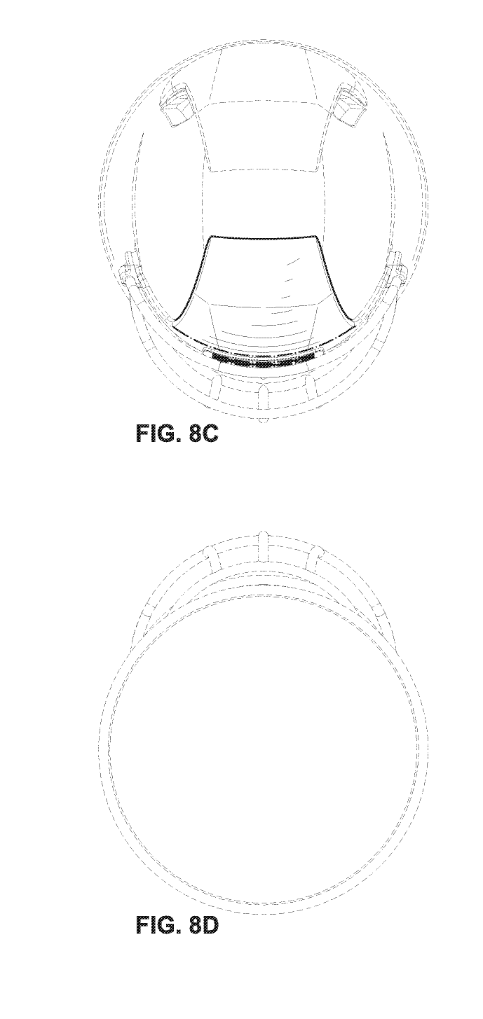

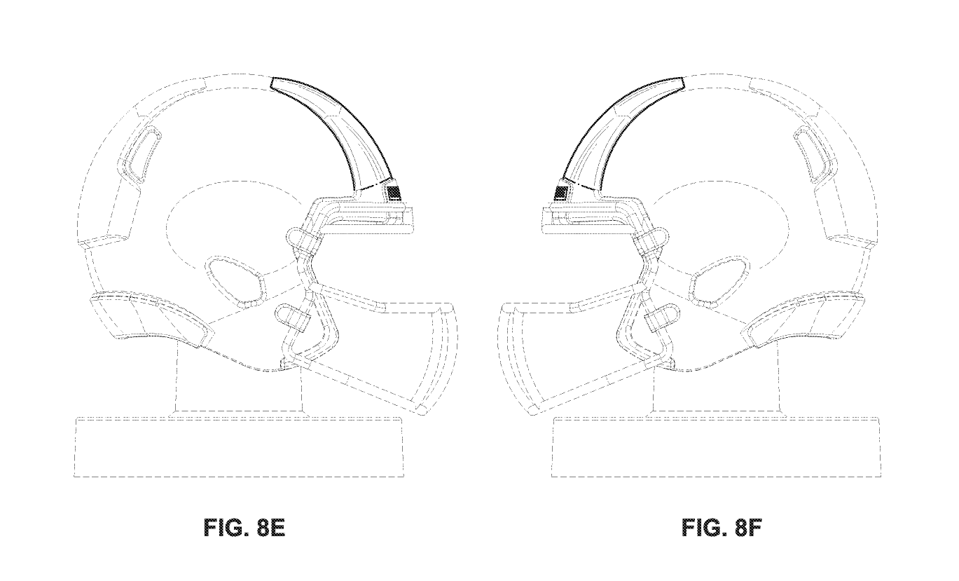

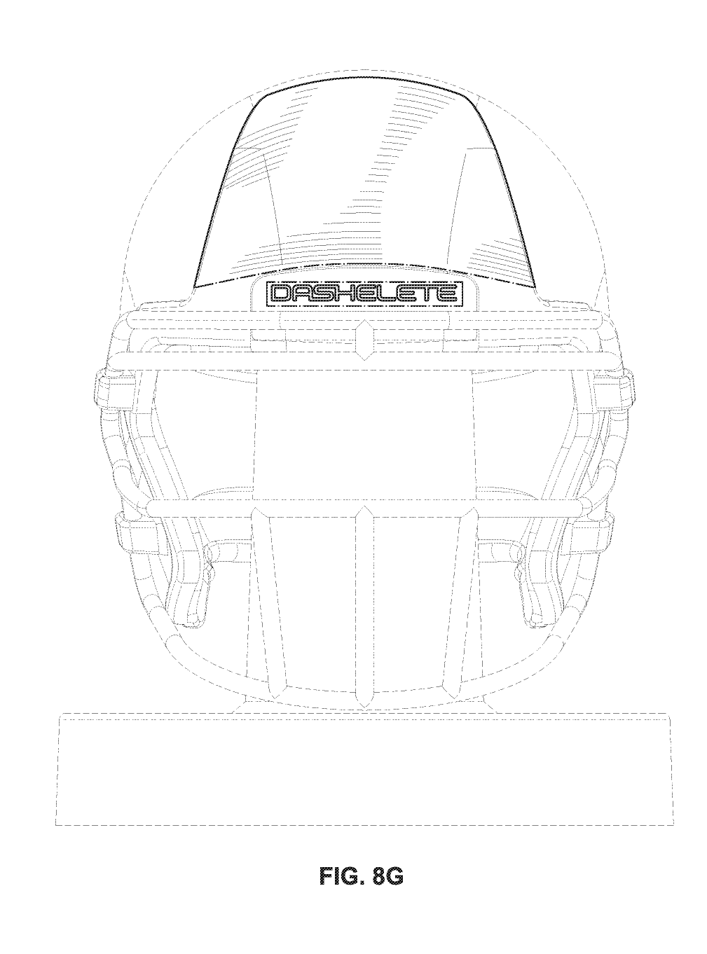

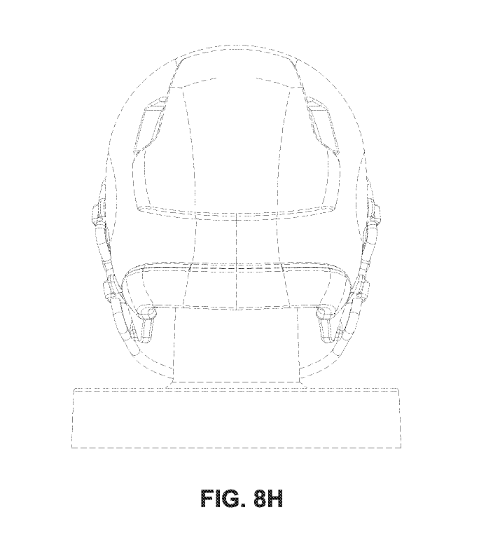

In addition it the present disclosure above, further included herein are FIGS. 6A-8H illustrating new ornamental designs for Novelty Helmet Assemblies. Specifically, FIGS. 6A-6H illustrate a first new ornamental design for a novelty helmet assembly where certain lines are solid (e.g., claimed) and other lines are dashed (e.g., unclaimed). It is specifically contemplated that any portion or portions of the solid lines in FIGS. 6A-6H can be converted to dashed lines and that any portion or portions of the dashed lines in FIGS. 6A-6H can be converted to solid lines. FIGS. 7A-7H illustrate a second new ornamental design for a novelty helmet assembly where certain lines are solid (e.g., claimed) and other lines are dashed (e.g., unclaimed). It is specifically contemplated that any portion or portions of the solid lines in FIGS. 7A-7H can be converted to dashed lines and that any portion or portions of the dashed lines in FIGS. 7A-7H can be converted to solid lines. FIGS. 8A-8H illustrate a third new ornamental design for a novelty helmet assembly where certain lines are solid (e.g., claimed) and other lines are dashed (e.g., unclaimed). It is specifically contemplated that any portion or portions of the solid lines in FIGS. 8A-8H can be converted to dashed lines and that any portion or portions of the dashed lines in FIGS. 8A-8H can be converted to solid lines.

The portions of the drawings (FIGS. 6A-8H) shown in broken or dashed lines represent environmental structure and form no part of the claimed design.

1. A novelty helmet assembly comprising:
a helmet having a first half and a second half, the first half of the helmet having a first pair of plates extending from an inner surface thereof and the second half of the helmet having a second pair of plates extending from an inner surface thereof, each of the first pair of plates forming a respective notch therein and each of the second pair of plates forming a respective notch therein, responsive to the first half of the helmet being directly attached to the second half of the helmet, the first pair of plates aligns with the second pair of plates thereby forming a pair of brackets, a first of the brackets having a first bracket opening formed by the notch of a first one of the first pair of plates and the notch of a first one of the second pair of plates and a second of the brackets having a second bracket opening formed by the notch of a second one of the first pair of plates and the notch of a second one of the second pair of plates; and
a stand having a body and a coupling mechanism extending from a top end surface of the body, the coupling mechanism including a first deflectable arm having a first locking tab and an opposing second deflectable arm having a second locking tab, the first locking tab being configured to directly engage the first bracket opening of the first bracket and the second locking tab being configured to directly engage the second bracket opening of the second bracket such that the coupling mechanism aids in rigidly coupling the helmet to the stand.

2. The novelty helmet assembly of claim 1, wherein the coupling mechanism further includes a pair of alignment protrusions extending from the top end surface of the body and being configured to aid in aligning the first bracket with the first deflectable arm and the second bracket with the second deflectable arm responsive to the helmet being coupled to the stand.

3. The novelty helmet assembly of claim 2, wherein each of the alignment protrusions has a first curved end and an opposing second curved end.

4. The novelty helmet assembly of claim 1, wherein the top end surface of the body includes a first slot positioned directly adjacent to the first deflectable arm that aids in permitting the first deflectable arm to deflect relative to the top end surface of the body and wherein the top end surface of the body includes a second slot positioned directly adjacent to the second deflectable arm that aids in permitting the second deflectable arm to deflect relative to the top end surface of the body.

5. The novelty helmet assembly of claim 1, wherein an end mating surface of the first half of the helmet includes a plurality of apertures therein and wherein an end mating surface of the second half of the helmet includes a plurality of pins extending therefrom, the plurality of pins being configured to engage the plurality of apertures to aid in maintaining the attachment of the first half of the helmet with the second half of the helmet.

6. The novelty helmet assembly of claim 1, further comprising a decal coupled to an outer surface of the first half of the helmet and an outer surface of the second half of the helmet such that the decal aids in maintaining the attachment of the first half of the helmet with the second half of the helmet.

7. The novelty helmet assembly of claim 1, further comprising a facemask coupled to a plurality of apertures in the first half of the helmet and a plurality of apertures in the second half of the helmet such that the facemask aids in maintaining the attachment of the first half of the helmet with the second half of the helmet.

8. The novelty helmet assembly of claim 1, further comprising a collar coupled to a rear edge surface of the first half of the helmet and a rear edge surface of the second half of the helmet such that the collar aids in maintaining the attachment of the first half of the helmet with the second half of the helmet.

9. The novelty helmet assembly of claim 1, wherein the body of the stand includes a stem extending from a base portion, the base portion having a bottom surface that is configured to aid in preventing the stand from moving relative to a surface upon which the novelty helmet assembly is placed.

10. The novelty helmet assembly of claim 9, wherein the bottom surface of the base portion includes or is coupled to a sticky layer, a glue layer, a silicone layer, a high friction layer, a hook and loop fastener, a magnet, or any combination thereof.

11. The novelty helmet assembly of claim 1, wherein each of the notches of the first pair of plates and each of the notches of the second pair of plates has a general “U” shape such that the first bracket opening has a generally rectangular shape and the second bracket opening has a generally rectangular shape.

12. A method of assembling a novelty helmet assembly, the method comprising:
providing a helmet having a first half and a second half, the first half of the helmet having a first pair of plates extending from an inner surface thereof and the second half of the helmet having a second pair of plates extending from an inner surface thereof, each of the first pair of plates forming a respective notch therein and each of the second pair of plates forming a respective notch therein;
attaching the first half of the helmet to the second half of the helmet such that the first pair of plates aligns with the second pair of plates thereby forming a pair of brackets, a first of the brackets having a first bracket opening formed by the notch of a first one of the first pair of plates and the notch of a first one of the second pair of plates and a second of the brackets having a second bracket opening formed by the notch of a second one of the first pair of plates and the notch of a second one of the second pair of plates;
providing a stand having a body and a coupling mechanism extending from a top end surface of the body, the coupling mechanism including a first deflectable arm having a first locking tab and an opposing second deflectable arm having a second locking tab; and
coupling the helmet to the stand including:
(i) engaging the first bracket with the first deflectable arm and engaging the second bracket with the second deflectable arm,
(ii) causing, via the pair of brackets, the first and the second deflectable arms to deflect relative to the top end surface of the body, and
(iii) directly engaging the first locking tab of the first deflectable arm with the first bracket opening of the first bracket and directly engaging the second locking tab of the second deflectable arm with the second bracket opening of the second bracket.

13. The method of claim 12, wherein the coupling mechanism further includes a pair of alignment protrusions extending from the top end surface of the body and being configured to aid in aligning the first bracket with the first deflectable arm and the second bracket with the second deflectable arm.

14. The method of 13, wherein each of the alignment protrusions has a first curved end and an opposing second curved end.

15. The method of claim 12, wherein the top end surface of the body includes a first slot positioned directly adjacent to the first deflectable arm that aids in permitting the first deflectable arm to deflect relative to the top end surface of the body and wherein the top end surface of the body includes a second slot positioned directly adjacent to the second deflectable arm that aids in permitting the second deflectable arm to deflect relative to the top end surface of the body.

16. The method of claim 12, wherein an end mating surface of the first half of the helmet includes a plurality of apertures therein and wherein an end mating surface of the second half of the helmet includes a plurality of pins extending therefrom, the attaching the first half of the helmet to the second half of the helmet including directly engaging the plurality of pins with the plurality of apertures.

17. The method of claim 12, further comprising, subsequent to the attaching of the first half of the helmet to the second half of the helmet, coupling a decal to an outer surface of the first half of the helmet and an outer surface of the second half of the helmet, thereby aiding in maintaining the attachment of the first half of the helmet with the second half of the helmet.

18. The method of claim 12, further comprising, subsequent to the attaching of the first half of the helmet to the second half of the helmet, coupling a facemask to a plurality of apertures in the first half of the helmet and a plurality of apertures in the second half of the helmet, thereby aiding in maintaining the attachment of the first half of the helmet with the second half of the helmet.

19. The method of claim 12, further comprising, subsequent to the attaching of the first half of the helmet to the second half of the helmet, coupling a collar to a rear edge surface of the first half of the helmet and a rear edge surface of the second half of the helmet, thereby aiding in maintaining the attachment of the first half of the helmet with the second half of the helmet.

20. The method of claim 12, wherein the body of the stand includes a stem extending from a base portion, the base portion having a bottom surface that is configured to aid in preventing the stand from moving relative to a surface upon which the novelty helmet assembly is placed, the method further comprising coupling a sticky layer, a glue layer, a silicone layer, a high friction layer, a hook and loop fastener, a magnet, or any combination thereof to the bottom surface of the base portion to aid in preventing the stand from moving relative to the surface upon which the novelty helmet assembly is placed.
